(19) United States
(12) Patent Application Publication
(10) Pub. No.: US 2008/0114673 A1
(43) Pub. Date: May 15, 2008

(54) Internet-based mortgage analysis and savings account implementation and management network

(76) Inventors: Richard Targett, Moraga, CA (US); Scott Sprouse, Cortlandt Manor, NY (US); Russ Aebig, Ladera Ranch, CA (US)

Correspondence Address: Thomas J. Perkowski, Esq., PC;Soundview Plaza, 1266 East Main Street, Stamford, CT, 06902, US

(21) Appl. No.: 11/599,158

(22) Filed: Nov. 14, 2006

(51) Int. Cl. G06Q 40/00

(52) U.S. Cl. 705/38

(57) ABSTRACT

Internet-based method of and system for enabling home owners with adjustable rate mortgage (ARM) and Interest Only (IO) loans to mitigate the financial risks associated with payment shock when the interest rates on their ARM or IO loans readjust during the life of such loans. The Internet-based system comprises a network of proxy servers, management servers, web (http) servers, application servers and database servers operably connected to the infrastructure of the Internet, for implementing the presentation, control and data entity layers of the MSA Network. In general, the financial services supported on the MSA Network include; (i) delivering mortgage loan holders with invitations to use and subscribe to services offered on the MSA Network; (ii) allowing mortgage loan holders to register with the MSA Network, perform what-if analysis with respect to their mortgage loans, and calculate a monthly savings amount that would be required to cover the loan readjustment in the event of an interest rate change on an ARM or IO loan; (iii) choosing investment vehicles and finding sources with which to fund the MSA; (iv) using an automated clearing house system (ACH) for automatically withdrawing funds from financial sources and depositing the, on a monthly basis, into the financial investment vehicles so as to implement the MSA; and (v) monitoring the performance of set up MSAs, including monthly deposits and balances. By virtue of the present invention, it is now possible for ARM or IO loan holders to mitigate the risks associated with mortgage rate changes and readjustment payment vulnerability, in the interests of borrowers, creditors, capital markets, mortgage loan service providers, and credit default modelers.

### BACKGROUND OF INVENTION

1. Field of Invention

The present invention relates to a novel Internet-based method of and system for enabling home owners with adjustable rate mortgage (ARM) loans and or Interest Only (IO) loans to mitigate the financial risks associated with payment shock when the interest rates on their ARM or IO loans readjust and or loan principal amortization is scheduled to begin during the life of such loans.

2. Brief Description of the State of Knowledge in the Art

Adjustable Rate Mortgage (M) and Interest Only (IO) loans, in general, and affordability products, in particular, create great uncertainty for (i) borrowers, (ii) creditors (and, by extension, capital markets), (iii) mortgage loan service providers, and (iv) credit default modelers.

On Sep. 29, 2006, a consortium of federal agencies including the Federal Reserve, FDIC, OCC and NCUA released final guidance on non-traditional residential mortgage products—commonly defined as Interest-Only loans and option ARMs. The final guidelines are similar to those proposed by the regulatory agencies back in December 2005. They encourage loan originators to:

(i) Consider the borrower's capacity to completely repay the loan at the fully-indexed amortizing rate over the entire term of the loan. For option ARM loans, a borrower's ability to repay the loan should be based on the original loan amount plus any negative amortization balance added to the loan;

(ii) Establish adequate risk management standards and capital requirements taking into account the increased risk of these mortgage products. Lenders should hold responsible allowances for losses due to these products; and

(iii) Provide consumers with sufficient information for them to fully understand the nature and risks of these loans.

Despite the importance of such federal guidelines described above, and the need for reading the “fine print”, many borrowers are unsophisticated. Consumers want to own a home and they will take out whatever mortgage is recommended to them to make their dreams become a reality. In many cases, they have not anticipated the impact of potential higher payments on their budget in the future. Additionally, there are no mortgage information support systems available after the initial mortgage transaction closes.

In the early 1980's, some argued that borrowers would never see single digit mortgage rates again. Most mortgages at that time were held by local financial institutions. They had lent long at relatively low rates while they were borrowing short at skyrocketing rates. Local institutions were losing money at an alarming rate. The “risk premium” they would demand in order to continue lending would keep mortgage rates in double digits. While such thinking had a certain logic to it, what these thinkers failed to anticipate was the creation of a national and international mortgage capital market where the risks of holding mortgage products could be shared among a base of investors much larger and deeper than local institutions could provide. The creation of GSEs (Government Sponsored Enterprises like GNMA, FNMA and Freddie Mac) ushered in this new era. This is a multi-trillion dollar market that has only matured in the last 30 years. Affordability products, with new structures and no history, create uncertainty in these capital markets and capital markets dislike uncertainty.

Mortgage service providers must also deal with the uncertainty of these new affordability products. They are sometimes obliged to make payment advances to the mortgage investors before receiving actual payments from the borrowers. In many instances, they must take the risk of advancing payments against late, delinquent (30 to 90 days late) or technically defaulted loans (over 90 days late) without a predictable history of how borrowers of these new products are apt to behave. They risk potential losses to the extent of which they are unable to anticipate within a predictable range.

Within the mortgage and mortgage-backed securities industry, sophisticated behavioral modeling of prepayment and credit default risk has made mortgage market participants more comfortable with buying mortgage backed securities and other fixed income products derived from mortgages. As the fixed income products have evolved in complexity, the modeling precision has evolved commensurately. Affordability products present a new disturbing problem of uncertainty. With little history to reference, modelers are at a “loss” to understand how to model these affordability products under different economic scenarios. With little comfort in the certainty of how borrowers of these loans will behave under duress, investors may demand a large risk premium if they are willing to consider buying these products at all.

All aspects of the United States economy are interrelated, including the interrelations between interest rates, the housing market, employment and the economy. It doesn't take a “perfect storm” to conjure up a scenario where increased interest rates (leading to higher mortgage rates) increase borrower mortgage default rates sending “shock waves” reverberating throughout the economy.

Many borrowers have already stretched their cashflow to the maximum to pay their current mortgages that are scheduled to re-set in the future at a potential interest rate higher than what they now pay. The Federal Reserve has raised short-term interest rates 0.25% fourteen times in a row as of the time of this writing. Adjustable rate mortgages are indexed off of various short-term rates. It is estimated that in 2005, 43% of first time home buyers actually put no money down in buying their homes.

Holders of interest only and payment option mortgages will not build up any equity in their homes from monthly mortgage payments since their payment contains no principal payment component. Any equity they hope to build up will only come through home price appreciation. In an environment of flat to declining home values, with little or no equity in their homes, it will be easier for them to walk away (i.e., default) on their loans than it would be otherwise if they had built up a large equity base mainly through appreciating home values.

As the frequency of default increases, it is likely that the inventory of unsold homes will increase as well. In an application of classical microeconomic theory, when supply increases while demand does not, prices must adjust downward in order for homes to be sold. In other words, an increase in the frequency of defaults is in this case, likely to increase the severity of the price loss, all other things being equal.

As prices decline and sellers become more reluctant to sell at these lower prices, the housing industry itself will experience a shake out. All members of the housing industry from builders to mortgage lenders to mortgage service providers will suffer. They will do less business resulting in less revenue and massive layoffs in this cyclical industry.

The capital markets upon which the mortgage market depends for its funding are already beginning to address the uncertainty that the new mortgage products have engendered by demanding more over collateralization (a form of risk premium) in the securitized deals that they issue in the public fixed income markets. In many cases, the issuing financial institutions retain the residual bond itself (the bond that loses value first from any credit defaults) and/or the mortgage servicing rights. These institutions are very vulnerable to the impact of mortgage defaults and this impact is magnified given the structure of these deals. As defaults increase, lenders will demand ever higher rates from borrowers (a growing risk premium) even as investors become ever more reluctant to invest.

Twenty years ago, home buyers typically put 20% down to buy a home, met income criteria, and hoped to own their home one day free and clear of any borrowings. The rapid appreciation of home prices in the early part of the 21^{st} century has changed the fundamental nature of home ownership. Many people put little or no money down, pay little or no principal, and hope to tap into the appreciation in their homes through home equity loans and lines. From a traditional perspective, such current practices look risky indeed. But the traditional perspective fails to come to grips with the new reality where it is more important to retain a home than own it free and clear.

Americans have become notoriously poor savers. Their savings rate as a percentage of income is barely positive and at times has turned negative, when, in many cases, in addition to spending all their earned income, Americans tap into the equity in their homes as a “substitute ATM machine.” The availability of no transaction cost home equity lines of credit has abetted such behavior. The Japanese, to cite a stark contrast, save to such an inordinate extent that their high savings rate negatively impacts economic growth. The Japanese can use their savings in any number of ways. Since Americans, in general, have little or no savings, the question of how they would direct these generalized accounts becomes a moot point.

The government and marketplace have addressed the absence of savings issue through the creation of what most generally can be referred to as “targeted savings accounts.” Many years ago, Americans had “Christmas clubs” where participants would set aside a certain amount of money weekly in order to have money available to purchase gifts during the Christmas Holiday season. These accounts generally were non-interest bearing. By putting money aside in these accounts, they would forego the interest they could have earned in a regular savings account. The discipline of a targeted savings account outweighed the gain of interest in a regular savings account in their minds. Similar thinking, now with added rather than decreased benefits, is at work with the following targeted savings plans.

In order to address the looming problem of retirees having inadequate retirement income (the result of inadequate savings), the government has created tax-advantaged retirement plans such as the Individual Retirement Account (IRA) and 401-k plans. In order to help parents meet future college educational costs for their children, the government has created tax-advantaged savings plans such as the 529s. In health care, the Health Savings Account (HSA) now exists to help individuals and families help with the costs in a more self-directed health care system. All these programs address the problem of inadequate savings through targeted savings plans.

The private financial marketplace has recently come up with the idea of rounding up bank charge card purchases to the next dollar with some minimal matching for the first few hundred dollars, and putting the money in a savings account. Such programs address the need for savings for a short period of time, but in absolute dollar terms, barely address the savings problem. GMAC has gone one step further. It employs the same round up credit card program, but uses the proceeds to pay down principal on a mortgage.

Accordingly, there is a great need in the art for an improved system and method that provides home owners and financial institutions with a superior approach to addressing the problem of mortgage payment risk and vulnerability in a highly unstable and competitive world.

### SUMMARY AND OBJECTS OF THE PRESENT INVENTION

Thus, it is a primary object of the present invention to provide an improved method of and system for mitigating the risks associated with mortgage rate changes and readjustment payment vulnerability, while avoiding the shortcomings and drawbacks associated with prior art systems and methodologies.

Another object of the present invention is to provide a novel Internet-based Mortgage Analysis, and Savings Account Implementation And Management Network (hereinafter the “Internet-based MSA Network”) that helps ARM and Interest Only (IO) borrowers understand the potential impact of rate changes and associated readjustment payments that must be paid in response thereto, and effective ways of mitigating these impacts by calculating the amount of money that must be saved, and setting up mortgage savings accounts (MSAs) on an Internet-based financial network, for such intended purposes.

Another object of the present invention is to provide such a novel Internet-based MSA Network, wherein the system automatically contact holders of adjustable-rate mortgage loans having any rate reset during the term of the mortgage, and solicit them to contribute, on a regular basis, to a mortgage savings account (MSA) that is set up with financial institutions who are registered with the MSA Network.

Another object of the present invention is to provide such a novel Internet-based MSA Network, wherein the system is capable of automatically contacting holders of adjustable-rate mortgage loans through various methods, including the automated transmission of separate slips/notices within the envelope accompanying monthly mortgage bills issued from the mortgage loan service providers registered with the MSA Network.

Another object of the present invention is to provide such a novel Internet-based MSA Network, wherein a Mortgage Analysis and Savings Calculation Module is provided and presented to users (e.g. mortgage loan holders) over a Web-based graphical user interface, for enabling mortgage holders to calculate how much money will need to be saved in a MSA each month in order to make the re-adjustment payment required on a particular ARM or Interest Only (IO) mortgage-backed loan.

Another object of the present invention is to provide such a novel Internet-based MSA Network, wherein a Financial Institution Registration Module is provided and presented to users (e.g. financial product vendors) over a Web-based graphical user interface, for allowing a financial institutions to register with the MSA Network as a financial institution (i.e. financial product vendor) that offers and support financial products which qualify as financial vehicles for implementing MSAs on the MSA Network, for eligible mortgage holders.

Another object of the present invention is to provide such a novel Internet-based MSA Network, wherein a Mortgage Loan Service Provider Registration Module is provided and presented to users (e.g. mortgage loan holders) over a Web-based graphical user interface, for registering a mortgage holder with the MSA Network and to set-up and implement a MSA with a selected registered financial institution on the MSA Network.

Another object of the present invention is to provide such a novel Internet-based MSA Network, wherein a Mortgage Holder Registration Module is provided and presented to users (e.g. mortgage loan holders) over a Web-based graphical user interface, for registering a mortgage holder with the MSA Network.

Another object of the present invention is to provide such a novel Internet-based MSA Network, wherein a Mortgage Savings Account (MSA) Registration and Set-Up Module is provided and presented to users (e.g. mortgage loan holders) over a Web-based graphical user interface, for registering a MSA with the MSA Network, and setting-up and implementing the MSA with a selected registered financial institution on the MSA Network.

Another object of the present invention is to provide such a novel Internet-based MSA Network, wherein a MSA Metrics Collection and Reporting Module is provided and presented to users (e.g. mortgage loan holders) over a Web-based graphical user interface, for allowing the MSA Network to collect MSA-related information from registered financial institutions offering and supporting MSAs on the MSA Network and allowing MSA holders to monitor their MSAs, and financial institutions to monitor information regarding MSA funding, and aggregate reports produced on MSAs for privacy reasons.

Another object of the present invention is to provide such a novel Internet-based mortgage analysis, and savings account registration and management network, wherein after a mortgage loan holder signs up with the MSA Network and sets up a MSA with a registered financial institution, regular financial contributions to the MSA can be made by electronic funds transfer (EFT) methods each month, collected by the MSA Network implementer, and deposited into the contributor's MSA.

Another object of the present invention is to provide such a novel Internet-based MSA Network, wherein the MSA Network hosts a website driven by a Mortgage Analysis and Saving Calculation Module, which allows ARM and IO loan holders to perform “What If? Analysis” to determine the amount of money they will need to save each month so as to avoid “payment reset shock” in the event of rate changes with their ARM loan.

Another object of the present invention is to provide such a novel Internet-based MSA Network, wherein the Mortgage Analysis and Savings Calculation Module supports a wide range of “What If?” scenarios can be automatically generated for those cases where the exact re-set interest rate is not yet known to the mortgage loan holder.

Another object of the present invention is to provide such a novel Internet-based MSA Network, wherein the Mortgage Analysis and Saving Calculation Module automatically requests the mortgage loan holder to supply mortgage loan data, including, information items such as (i) the size of the loan, (iii) the term of loan and periodicity, (iii) reset dates, and (iv) periodic and lifetime caps and floors on interest rates.

Another object of the present invention is to provide such a novel Internet-based MSA Network, wherein the Mortgage Analysis and Saving Calculation Module is programmed with simplifying default assumptions so that the mortgage loan holder (i.e. network/system user) does not need to become initially bewildered by all the factors that can apply in adjustable rate mortgage (ARM) and Interest Only (IO) scenarios.

Another object of the present invention is to provide such a novel Internet-based MSA Network, wherein the Mortgage Analysis and Saving Calculation Module employs Simplifying Assumptions including the projecting of: (1) the amount that needs to be saved will be the sum of the new payments over the length of the new adjustment period minus the sum of existing payments over that period (e.g. if a 4% three year hybrid re-adjusts to a 5% one year ARM, the total amount to be saved will equal the difference between the 5% and 4% payments during the one year re-adjustment period); and (2) the amount to be saved is a gross amount with no interest accruing during the re-set period and, a fortiori, with no compounding of interest (although some simple compounding assumptions can be built into the mortgage savings amount calculations.) Another object of the present invention is to provide such a novel Internet-based MSA Network, wherein in Mortgage Analysis and Saving Calculation Module of the illustrative embodiment uses such simplifying assumptions, and then calculates the monthly savings amount (that the mortgage loan holder needs to pay into the MSA) by dividing the total amount computed using Simplifying Assumption No. 1 above, by the number of months left until interest rate re-adjustment occurs.

Another object of the present invention is to provide such a novel Internet-based MSA Network, wherein the Mortgage Analysis and Saving Calculation Module is presented to ARM or IO loan holders by way of Web-site that enables users to enter relevant loan characteristics into the database of the MSA Network, or import such loan information from ones mortgage loan service provider, or other appropriate database, and thereafter the module automatically calculates the amount that needs to be saved on a monthly basis, and then allows the loan holder to set up an MSA account with a registered financial institution, including the selection of investment vehicles for the MSA, and the financial sources for funding the same, and thereafter monitoring the performance of investment and returns via an account monitoring metrics module also supported by the MSA Network of the present invention.

Another object of the present invention is to provide such a novel Internet-based MSA Network, wherein Mortgage Savings Accounts (MSAs) set up and implemented over the MSA Network of the present invention will serve as a buffer to mitigate negative events associated with interest rate increases on ARM and IO type loans, so that home-owners will be less likely to have their mortgage loans fall into delinquency or default, and face the possibility of losing their homes.

Another object of the present invention is to provide such a novel Internet-based MSA Network, wherein for each Mortgage Savings Account set up and implemented on the MSA Network, monthly payments are made to a third party financial institution, independent from the current mortgage loan service provider, so that the mortgage loan holder will have all options open at the time of his/her rate readjustment, including the option to refinance with a different mortgage loan company that may offer better rates or terms.

Another object of the present invention is to provide such an Internet-based system comprises a network of proxy servers, management servers, web (http) servers, application servers and database servers operably connected to the infrastructure of the Internet, for implementing the presentation, control and data entity layers of the MSA Network.

Another object of the present invention is to provide an Internet-based method and system for delivering financial services to mortgage loan holders, namely; (i) delivering mortgage loan holders with invitations to use and subscribe to services offered on the MSA Network; (ii) allowing mortgage loan holders to register with the MSA Network, perform what-if analysis with respect to their mortgage loans, and calculate a monthly savings amount that would be required to cover the loan readjustment in the event of an interest rate change on an ARM or IO loan; (iii) choosing investment vehicles and funding sources with which to fund the MSA; (iv) using an automated clearing house system (ACH) for automatically withdrawing funds from financial sources and depositing the, on a monthly basis, into the financial investment vehicles so as to implement the MSA; and (v) monitoring the performance of set up MSAs, including monthly deposits and balances.

Another object of the present invention is to provide such an Internet-based method and system that makes it possible for ARM and IO loan holders to mitigate the risks associated with mortgage rate changes and readjustment payment vulnerability, in the interests of borrowers, creditors, capital markets, mortgage loan service providers, and credit default modelers.

These and other objects of the present invention will become apparent hereinafter and in the claims to invention appended hereto.

### BRIEF DESCRIPTION OF THE DRAWINGS

For a more complete understanding of how to practice the Objects of the Present Invention, the following Detailed Description of the Illustrative Embodiments can be read in conjunction with the accompanying Drawings, briefly described below, wherein like reference numerals are indicate like structures.

FIG. 1 is a schematic representation of the system architecture of the Internet-based Mortgage analysis, and Savings Account registration, and management services network of the present invention, shown comprising proxy servers, communication servers, a management server, web servers, application servers, and database servers operably connected to the infrastructure of the Internet, and/or other global packet data communications network, as well as automated electronic and physical mail processing, delivery and distribution systems of global extent;

FIG. 2 is a schematic representation of the parties and services supported by the MSA Network of the present invention shown in FIG. 1, namely: (i) ARM and IO mortgage loan holders receive an invitation to use the MSA Network, by network administrator, mortgage loan servicing companies, financial institutions and/or marketing agents, via its automated electronic and physical mail processing, delivery and distribution systems; (ii) upon considering to set up a MSA, the mortgage holders interact with the MSA Network by registering therewith, performing what-if analysis, and choosing investment vehicles, and at least one bank account from which to withdraw funds for funding the implementation of the registered MSA; and (iii) using an automated clearing house (ACH) system (ACH) for automatically withdrawing funds each month from funding sources and depositing the same into the financial investment products of registered financial institutions, so as to implement the MSA;

FIG. 3 is a schematic representation of the Internet-based MSA Network of the present invention, illustrating the service modules supported by its application, communication and database servers, namely, (i) a Mortgage Loan Service Provider Registration Module for registering mortgage loan service providers with the MSA Network who wish for their customers to be contacted and invited by the MSA Network administrators to use the MSA Network and its financial services, (ii) a Mortgage Holder Registration Module for registering a mortgage holder with the MSA Network, (iii) a Financial Institution Registration Module for allowing a financial institution to register with the MSA Network as a financial institution that will offer and support financial investment products on the MSA Network to eligible mortgage holders, (iv) a Mortgage Analysis and Savings Calculation Module for automatically analyzing mortgages and enabling mortgage holders to calculate how much money will need to be saved each month in a MSA set up in order to save for and make the re-adjustment payment required on a particular ARM, (v) a Mortgage Savings Account (MSA) Registration and Set-Up Module for registering a MSA with the MSA Network and to setting-up and implementing the MSA with a selected registered financial institution on the MSA Network, and (vi) a MSA Metrics Collection and Reporting Module for allowing the MSA Network to collect MSA-related information from registered financial institutions offering and supporting MSAs on the MSA Network and allowing MSA holders to monitor their MSAs, an financial institutions to monitor information regarding MSA funding, and aggregate reports produced on MSAs for privacy reasons;

FIG. 3A is a schematic representation of the Mortgage Loan Service Provider Registration Module supported on the Internet-based MSA Network of the present invention;

FIG. 3B is a schematic representation of the Mortgage Holder Registration and MSA Set-Up Module supported on the Internet-based MSA Network of the present invention;

FIG. 3C is a schematic representation of the Financial Institution Registration Module supported on the Internet-based MSA Network of the present invention;

FIG. 3D is a schematic representation of the Mortgage Analysis and Saving Calculation Module supported on the Internet-based MSA Network of the present invention;

FIG. 3E is a schematic representation of the Mortgage Savings Account (MSA) Registration and Set-Up Module supported on the Internet-based MSA Network of the present invention;

FIG. 3F is a schematic representation of the MSA Metrics Collection and Reporting Module supported on the Internet-based MSA Network of the present invention;

FIG. 3G is a schematic representation of the object-relational model underlying the MSA Network of the illustrative embodiment of the present invention, showing the primary objects associated with the enterprise of the MSA Network and the linkages associated with such objects;

FIG. 4A is a schematic representation of an exemplary Web-based graphical user interface (GUI) supported by the Internet-based MSA Network of the present invention, wherein a network user (i.e. mortgage holder) can log-onto the MSA Network (via a simple registration process), and subsequently use the innovative services offered by the MSA Network of the present invention;

FIG. 4B is a schematic representation of an exemplary Web-based graphical user interface (GUI) supported by the Internet-based MSA Network of the present invention, wherein the mortgage holder can enter unique loan identifiers (i.e. loan number and mortgage company) as search keys to search for corresponding loan records stored in an industry-standard Loan Performance Database, such as the MISMO Database;

FIG. 4C is a schematic representation of an exemplary Web-based graphical user interface (GUI) supported by the Internet-based MSA Network of the present invention, wherein, if the Mortgage Analysis and Savings Calculation Module identifies the loan in the MISMO Database, then all characteristics of the loan are automatically returned from the MISMO Database to the Mortgage Analysis and Savings Calculation Module, and if the Mortgage Analysis and Savings Calculation Module does not identified the loan in the MISMO database, then a null value is automatically returned to the Mortgage Analysis and Savings Calculation Module, indicating that the loan was not found in the database;

FIG. 4D is a schematic representation of an exemplary Web-based graphical user interface (GUI) supported by the Internet-based MSA Network of the present invention, wherein the Mortgage Analysis and Savings Calculation Module automatically updates the status field for each mortgage loan under analysis, indicating that the information has been received by the RDBMS server of the Internet-based MSA Network of the present invention;

FIG. 4E is a schematic representation of an exemplary Web-based graphical user interface (GUI) supported by the Internet-based MSA Network of the present invention, wherein when the mortgage holder presses the “OK” (i.e. Savings Calculation) Button, the Mortgage Analysis and Savings Calculation Module automatically performs calculations on how much must be saved each month to make the total loan readjustment payment), and presents detailed screens indicating the same and related loan information;

FIG. 4F is a schematic representation of an exemplary Web-based graphical user interface (GUI) supported by the Internet-based MSA Network of the present invention, wherein the Mortgage Analysis and Savings Calculation Module automatically uses detailed information retrieved from the MISMO Database to populate the appropriate information fields in tabbed dialogue boxes labeled Loan Basics, Loan Resets, Floors, and Caps, and wherein the mortgage holder (network user) has opportunity to modify any of the information provided in earlier steps, and the Mortgage Analysis and Savings Calculation Module provides the total amount to be saved per month, and with each change to information provided to the Module, the Module automatically calculates and presents a new total monthly amount to be saved by the mortgage holder;

FIG. 4G is a schematic representation of an exemplary Web-based graphical user interface (GUI) supported by the Internet-based MSA Network of the present invention, wherein when the user presses the OK button shown in FIG. 4E, the MSA Network automatically advances control to the Mortgage Savings Account (MSA) Registration and Set-Up Module, where the user is presented a MSA Registration screen, displaying (i) various investment vehicles (“Options”) for implementing the MSA (and its calculated savings amounts) offered by various financial institutions registered on the Internet-based MSA Network of the present invention, as well as (ii) the Funding Source for finding the MSA, identified by its financial account number, ABA number, Routing Number, Data of Month to Withdraw, and Monthly Amount;

FIG. 4H is a schematic representation of an exemplary Web-based graphical user interface (GUI) supported by the Internet-based MSA Network of the present invention, wherein the user selects, from the displayed MSA Registration screen, the investment vehicle (“Option”) for implementing the MSA (and its calculated savings amounts) using selected investment products offered by financial institutions registered on the MSA Network;

FIG. 4I is a schematic representation of an exemplary Web-based graphical user interface (GUI) supported by the Internet-based MSA Network of the present invention, wherein the mortgage holder provides the banking information into the Funding Source section of the GUI screen, and instructing the MSA Network to automatically withdraw funds in accordance with the information supplied, using the ACH processing to automate funds withdrawal and depositing, while the Mortgage Analysis and Savings Calculation Module automatically verifies the validity of the information entered using this GUI screen;

FIG. 4J is a schematic representation of an exemplary Web-based graphical user interface (GUI) supported by the Internet-based MSA Network of the present invention, wherein the mortgage holder may, at any time, activate the MSA Metrics Collection and Reporting Module and display this MSA Account Management GUI Screen, review the history of payments made into any particular MSA set up on the MSA Network, as well as the status of those investments, and select the financial institution implementing the MSA, which automatically takes the user directly to the WWW site of the financial institution for tracking funds deposited with, and managed by this financial institution (i.e. vendor); and

FIG. 5 is a schematic representation of the various process flows supported by the Internet-based MSA Network of the present invention, among Mortgage Loan Holders, the Mortgage Analysis and Saving Calculation Module, the MISMO database, the Automated Clearing House (ACH) system, and the Financial Institutions registered on the MSA Network of the present invention.

### DETAILED DESCRIPTION OF THE ILLUSTRATIVE EMBODIMENTS OF THE PRESENT INVENTION

Referring to the figures in the accompanying Drawings, the various illustrative embodiments of the present invention will be described in great detail, wherein like elements will be indicated using like reference numerals.

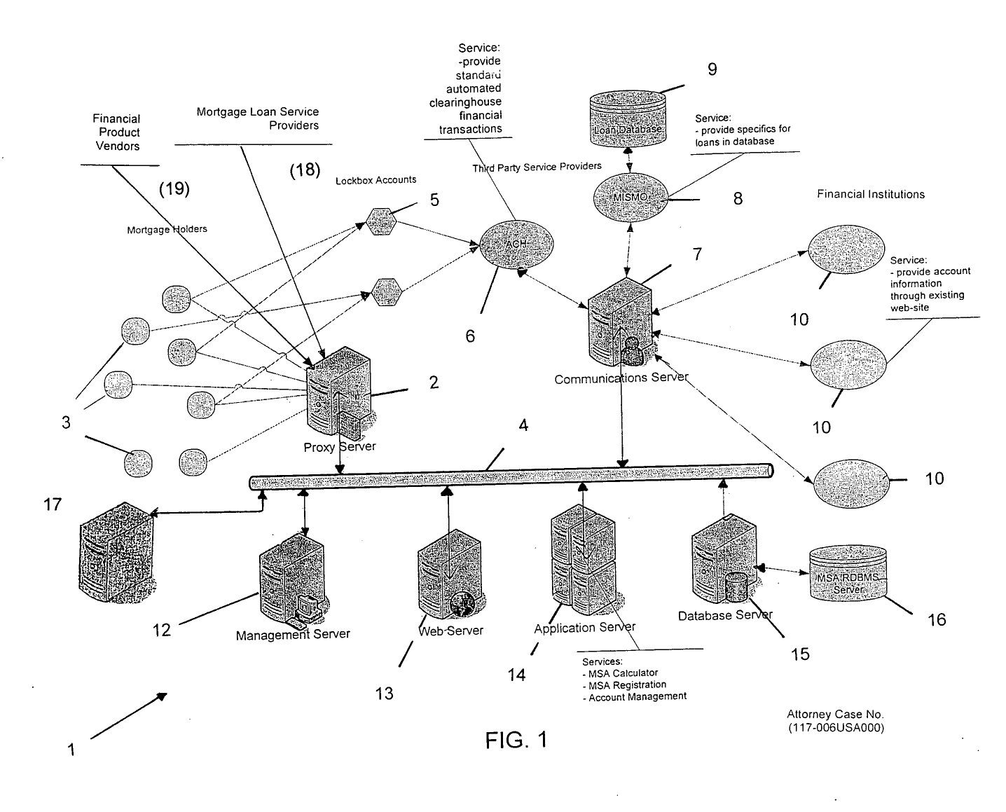

In FIG. 1, the system architecture of the Internet-based Mortgage Analysis, and Savings Account Registration and set-up (i.e. Implementation), and management services network 1 of the present invention is shown comprising: a plurality of proxy servers 2 providing ARM and IO mortgage loan holders 3, mortgage loan service providers 18, financial institutions (product vendors) 19, access to the MSA Network of the present invention (and lockbox amounts 5 connected to automated clearing house ACH system 6), by way of the infrastructure of the Internet 4, simply by using a Web-enabled browser program running on virtually any kind of client machine; a plurality of communication servers 7 interfacing industry-standard mortgage loan database services (e.g. MISMO) known in the art and the information server 10 associated with financial institution originating ARM loans and the like; a management server 12 for allowing network administrators to management the MSA Network of the present invention using TCP/IP connectivity; a plurality of web (http) servers 13 operably connected to the infrastructure of the Internet, for realizing the presentation layer of the MSA Network Application of the present invention; a plurality of application servers 14 for implementing the control layer of the MSA Network Application; and database servers 15 operably connected to the infrastructure of the Internet and SQL-based RDBMSs 16, for implementing the data entity layer of the MSA Network Application; as well as automated electronic and physical mail processing, delivery and distribution systems 17 of global extent, for sending invitations to mortgage (e.g. ARM or IO) loan holders to visit the home page of WWW site maintained by MSA Network administrators, where mortgage loan holders quickly can register with (i.e. log-in with) the MSA Network and access its innovative financial services using any Web-enabled computer (e.g. desktop PCs, laptop computers, WAP-enabled mobile computers and cell phones, and the like).

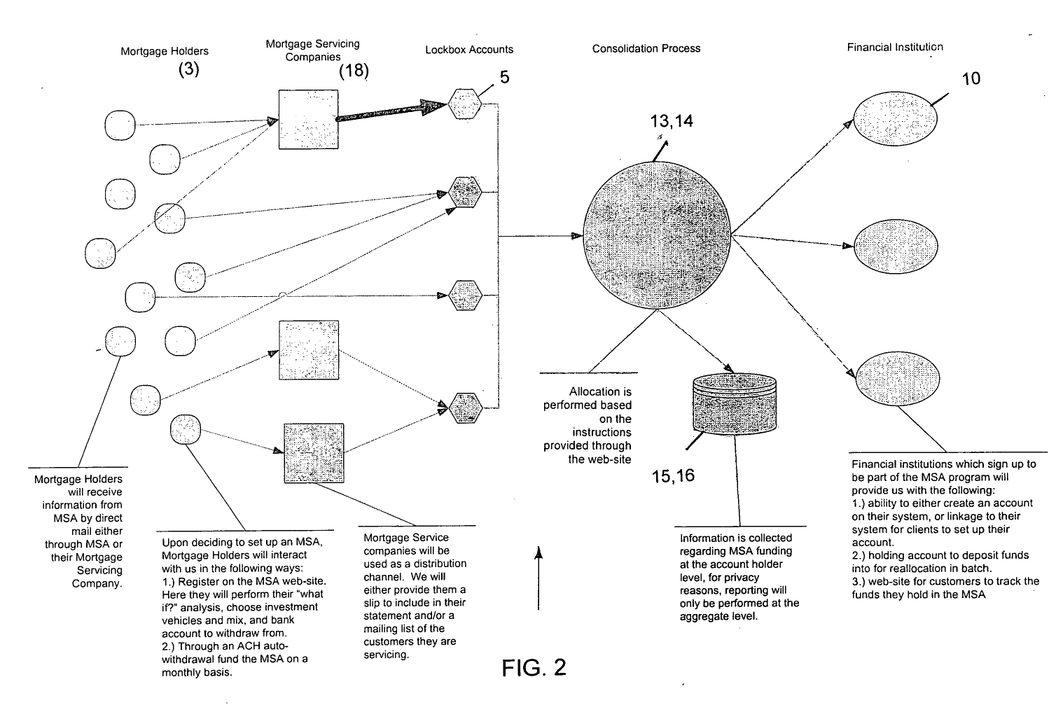

As shown in FIG. 2, the MSA Network of the present invention shown in FIG. 1 supports diverse financial services involving various parties including, for example, mortgage loan holders, mortgage loan service providers, financial institutions offering investment vehicles and options for implementing MSAs on the MSA Network, automated clearing house (ACH) service providers for enabling automated funds withdrawal and depositing, and industry-standard MISMO Database service provider, et al.

In general, the financial services supported on the MSA Network of the present invention include; (i) mortgage holders receiving information from the MSA Network, or mortgage loan servicing companies via (via its automated electronic and physical mail processing, delivery and distribution systems) inviting the mortgage loan holders to use and subscribe to services offered on the MSA Network of the present invention; (ii) allowing any mortgage loan holder to register with the MSA Network, and perform what-if analysis with respect to its mortgage loans, and calculation of a monthly savings amount that would be required to cover the loan readjustment in the event of an interest rate change on an ARM or IO loan; and (iii) choosing investment vehicles and funding sources (i.e. least one bank account) from which to withdraw funds for funding the MSA; (iv) using an automated clearing house system (ACH) for automatically withdrawing funds from financial sources and depositing the same into the MSA on a monthly basis; and (v) monitoring the performance of set up MSAs, including monthly deposits and balances.

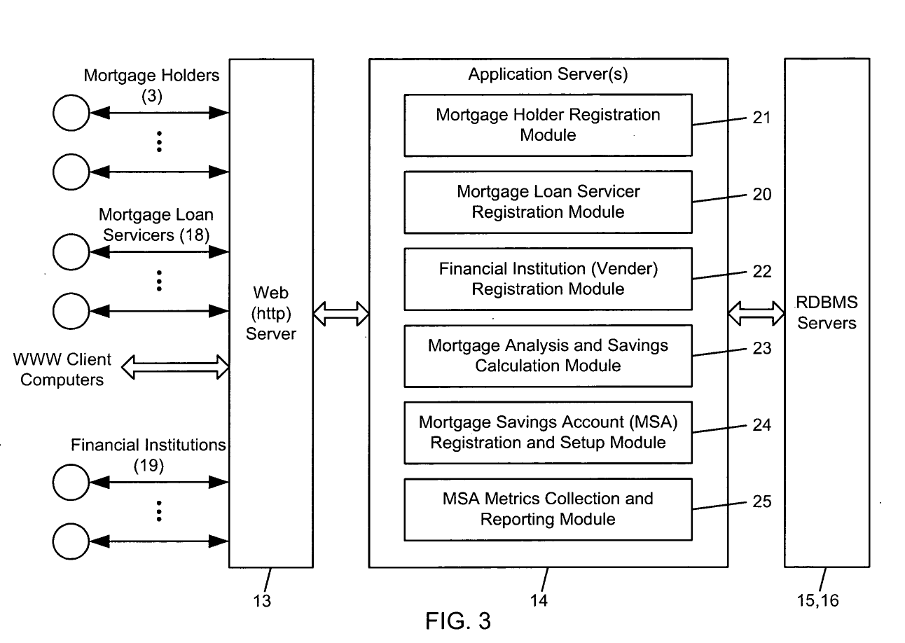

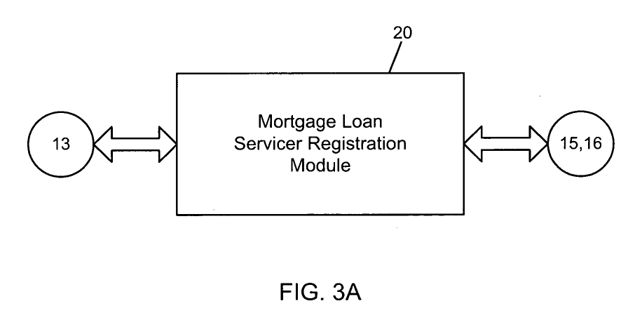

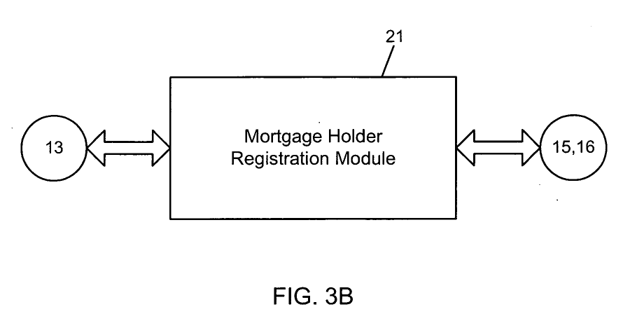

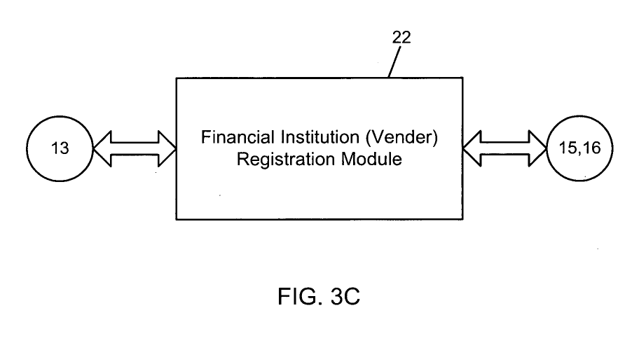

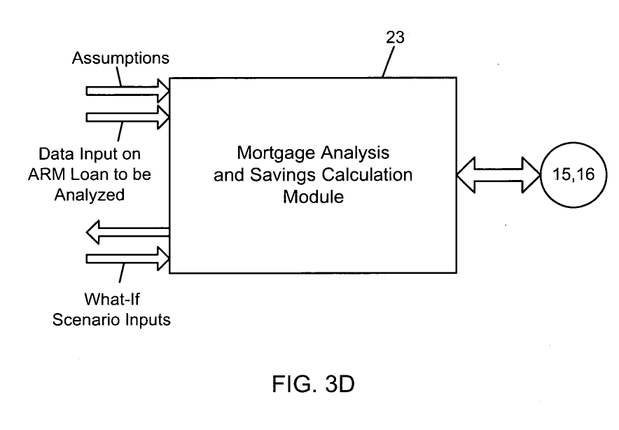

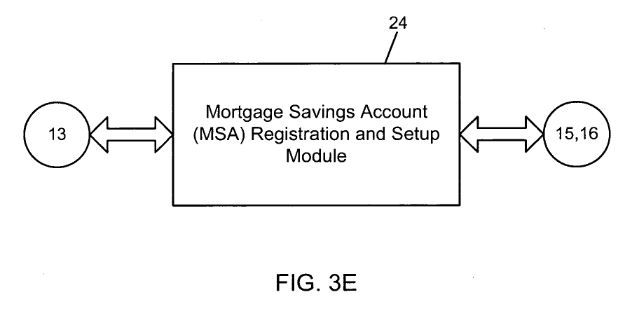

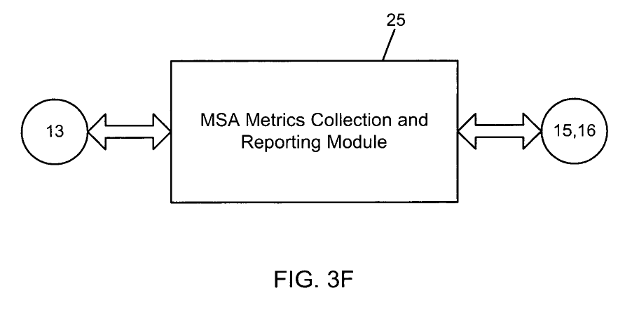

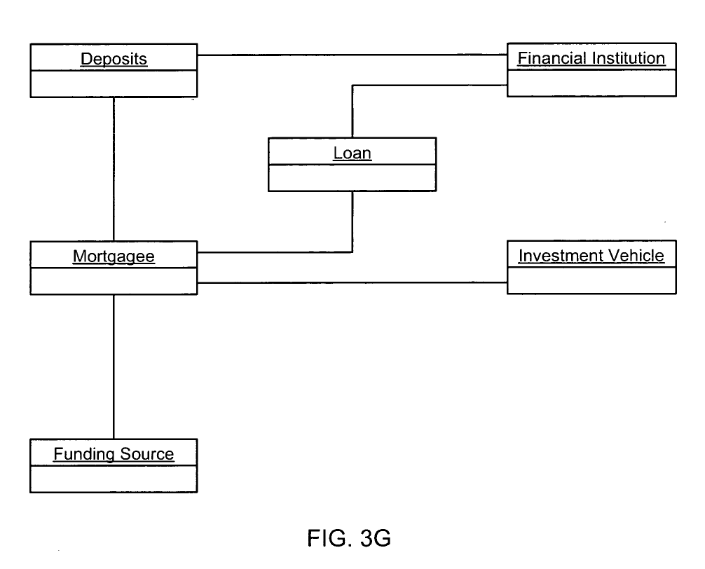

In order to support such innovative services, the Internet-based MSA Network of the present invention, including its communication, application and database servers, supports a number of service modules, as shown in FIG. 3, namely:

(i) a Mortgage Loan Service Provider Registration Module 20 for registering a mortgage loan service provider on the MSA Network;

(ii) a Mortgage Holder Registration Module 21 for registering a mortgage holder with the MSA Network to use the services provided thereon;

(iii) a Financial Institution Registration Module 22 for allowing a financial institution to register with the MSA Network as a financial institution that will offer and support MSAs on the MSA Network to eligible mortgage holders;

(iv) a Mortgage Analysis and Savings Calculation Module 24 for automatically analyzing mortgages and enabling mortgage holders to calculate how much money will need to be saved each month in a MSA set up in order to save for and make the re-adjustment payment required on a particular ARM or IO;

(v) a Mortgage Savings Account Registration and Set-Up Module 24 for registering a mortgage savings account on the MSA Network and setting-up and implementing the MSA with a selected registered financial institution (i.e. vendor) on the MSA Network;

(vi) a MSA Metrics Collection and Reporting Module 25 for allowing the MSA Network to collect MSA-related information from registered financial institutions offering and supporting MSAs on the MSA Network and allowing MSA holders to monitor their MSAs, an financial institutions to monitor information regarding MSA funding, and aggregate reports produced on MSAs for privacy reasons.

These service modules supported on the MSA Network will be described in greater detail below.

As shown in FIG. 3A, the Mortgage Loan Service Provider Registration Module 20 of the illustrative embodiment comprises object-oriented software technology (e.g. implemented using the Java or C# programming language) running on the application servers of the MSA Network, and supported by its communication, web and database servers, so that mortgage loan service providers can be quickly registered with the MSA Network so that their customers can be automatically contacted and invited by MSA Network administrators to use the MSA Network and its financial services.

As shown in FIG. 3B, the Mortgage Holder Registration Module 21 of the illustrative embodiment comprises object-oriented software technology (e.g. implemented using the Java or C# programming language) running on the application servers of the MSA Network, and supported by its communication, web and database servers, so that a mortgage holder can register with the MSA Network and use the services provided on the MSA Network.

As shown in FIG. 3C, the Financial Institution Registration Module 22 of the illustrative embodiment comprises object-oriented software technology (e.g. implemented using the Java or C# programming language) running on the application servers of the MSA Network, and supported by its communication, web and database servers, so that a financial institutions can register with the MSA Network and offer and support financial products and options for implementing MSAs on the MSA Network to eligible and qualified mortgage holders.

As shown in FIG. 3D, the Mortgage Analysis and Saving Calculation Module 23 of the illustrative embodiment comprises object-oriented software technology running on the application servers of the MSA Network, and supported by its communication, web and database servers, so that the MSA Network can automatically analyze adjustable rate mortgages (ARMs) and IO loan products (e.g. using “What If Analysis”) and enable mortgage holders to quickly calculate how much money they will need to be save each month in a registered MSA set up on the MSA Network in order to save for and make the re-adjustment payment required on a particular ARM loan.

In general, the Mortgage Analysis and Savings Calculation Module 23 is designed to provide powerful online, expert decision support regarding (i) one's adjustable rate mortgage (ARM) loan(s), and (ii) a reliable calculation of how much one needs to save, on monthly basis, in order to have sufficient money to make the re-adjusted payment at the time when the interest rate of the mortgage loan changes in response to market and/or other condition upon which the mortgage loan is based.

During operation, the Mortgage Analysis and Saving Calculation Module 23 automatically requests the mortgage loan holder to supply mortgage loan data (as Input Data), including, information items such as (i) the size of the loan, (iii) the term of loan and periodicity (i.e. defaults to monthly), (iii) reset dates, (iv) reset rates, and (iv) periodic and lifetime caps and floors on interest rates (which can be a function of geographic region). All such information items can be manually entered into the RDBMS of the MSA Network by the mortgage loan holder, or more preferably, the loan holder can provide the MSA Network with the loan's unique account/ID number, and such information is automatically imported into the MSA Network's databases from the industry-standard MISMO database 9 where such loan characteristic information is maintained.

The Mortgage Analysis and Savings Calculation Module 23 supports a wide range of “What If?” scenarios can be automatically generated for those cases where the exact re-set interest rate is not yet known to the mortgage loan holder. In the illustrative embodiment, the Mortgage Analysis and Saving Calculation Module is programmed with simplifying default assumptions so that the mortgage loan holder (i.e. network/system user) does not need to become initially bewildered by all the factors that can apply in adjustable rate mortgage (ARM) and/or IO mortgage loan scenarios. Simplifying Assumptions (i.e. logic) include the projecting of: (1) the amount that needs to be saved will be the sum of the new payments over the length of the new adjustment period minus the sum of existing payments over that period (e.g. if a 4% three year hybrid re-adjusts to a 5% one year ARM, the total amount to be saved will equal the difference between the 5% and 4% payments during the one year re-adjustment period); and (2) the amount to be saved is a gross amount with no interest accruing during the re-set period and, a fortiori, with no compounding of interest (although some simple compounding assumptions can be built into the mortgage savings amount calculations.) Using such simplifying assumptions, the Mortgage Analysis and Saving Calculation Module then calculates the monthly savings amount (that the mortgage loan holder needs to pay into the MSA) by dividing the total amount computed using Simplifying Assumption No. 1 above, by the number of months left until interest rate re-adjustment occurs. Such analysis and computations can include factors such as interest rates based on geographic region, as well as FICO scores for particular individuals. The resulting figure is displayed to the mortgage holder for consideration, and subsequently used by the Mortgage Savings Account Registration and Set-Up Module to set up a MSA on the MSA Network of the present invention.

As shown in FIG. 3E, the Mortgage Savings Account Registration and Set-Up Module 24 of the illustrative embodiment comprises object-oriented software technology (e.g. implemented using the Java or C# programming language) running on the application servers of the MSA Network, and supported by its communication, web and database servers, so that a mortgage holder can register with the MSA Network and quickly set-up and implement the MSA with a selected registered financial institution (i.e. financial product vendor) on the MSA Network.

As shown in FIG. 3F, the MSA Metrics Collection and Reporting Module 25 of the illustrative embodiment comprises object-oriented software technology (e.g. implemented using the Java or C# programming language) running on the application servers of the MSA Network, and supported by its communication, web and SQL database servers, so that the MSA Network can automatically collect MSA-related information from registered financial institutions (i.e. vendors) offering and supporting financial products that have been selected by mortgage loan holders to implement MSAs on the MSA Network, and allowing these MSA holders to monitor their MSAs, and for financial institutions to monitor information regarding MSA funding, and aggregate reports produced on MSAs for privacy reasons.

FIG. 3G shows the object-relational model underlying the MSA Network of the illustrative embodiment of the present invention, comprising of the primary objects associated with the MSA Network enterprise, including Deposits, Loan, Mortgages, Financial Institution, Investment Vehicle, and Funding Source, and showing the relational linkages associated with such objects;

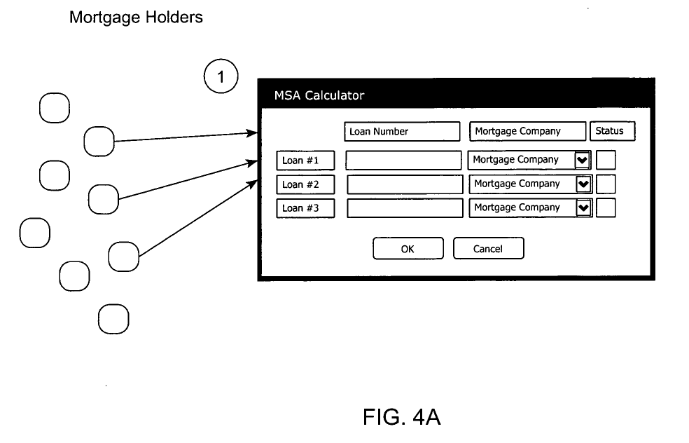

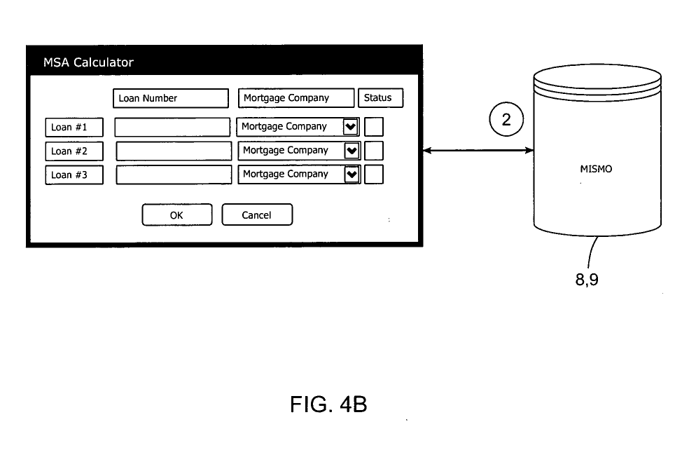

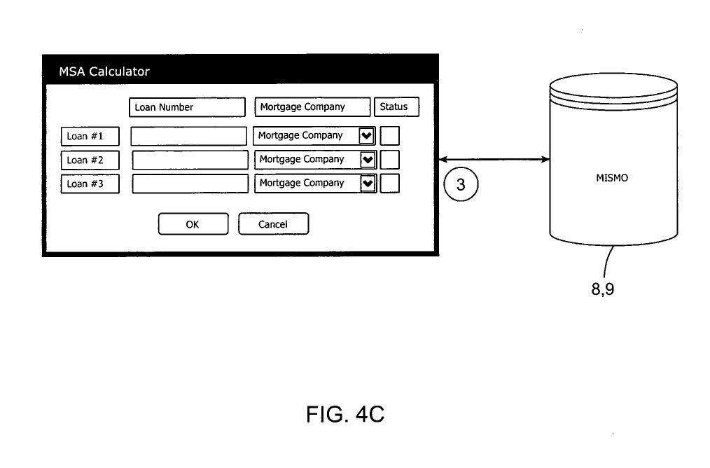

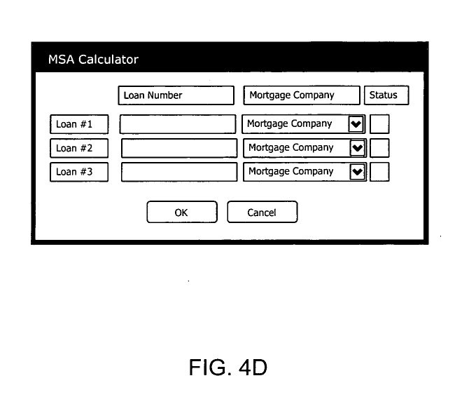

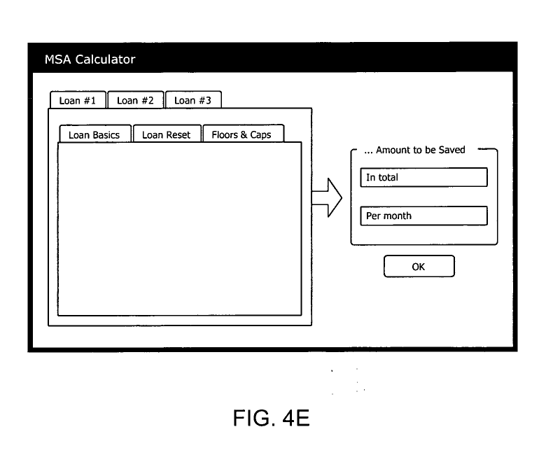

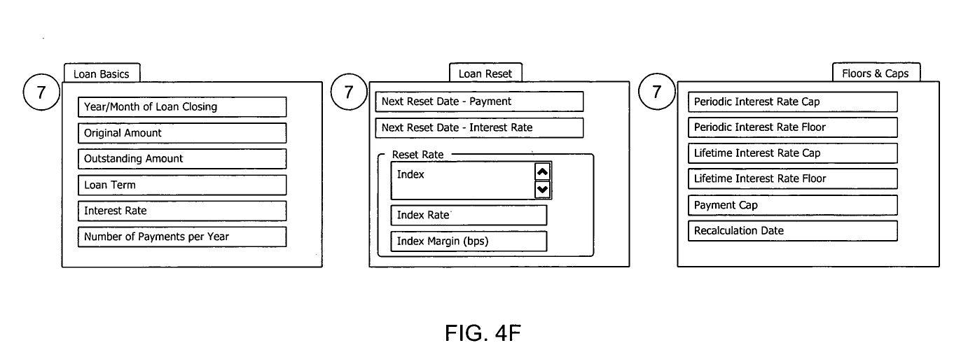

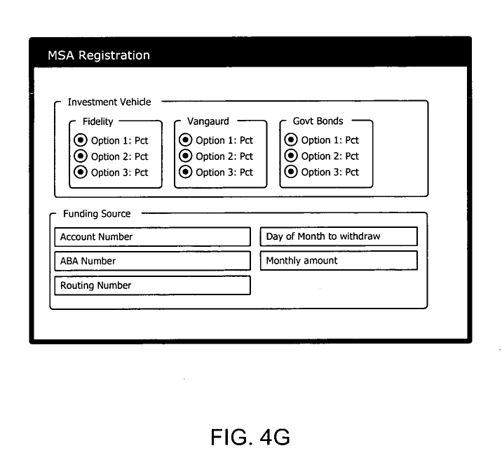

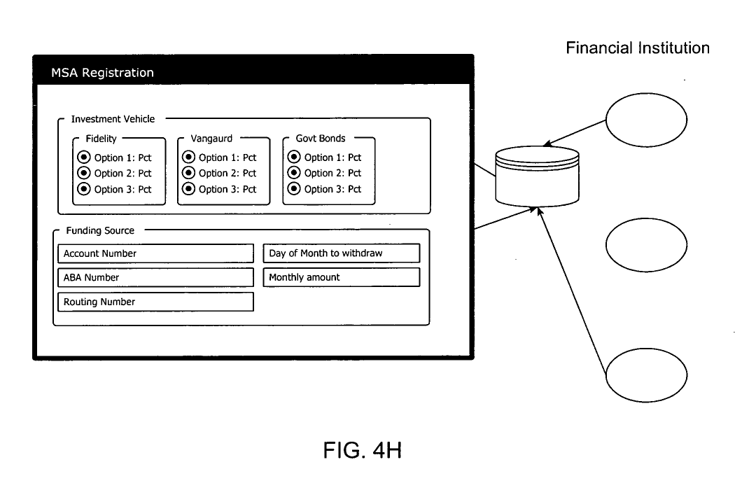

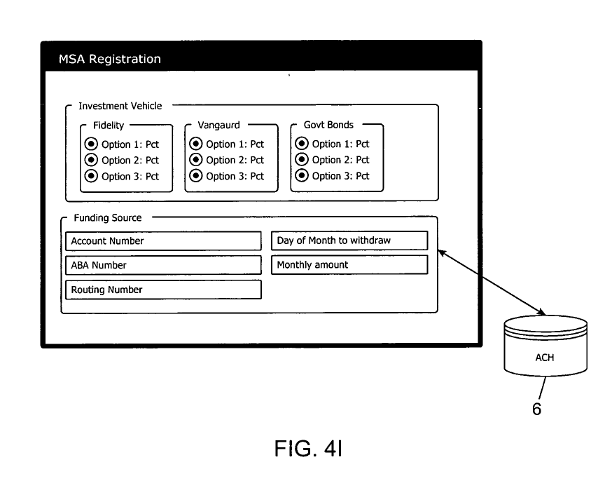

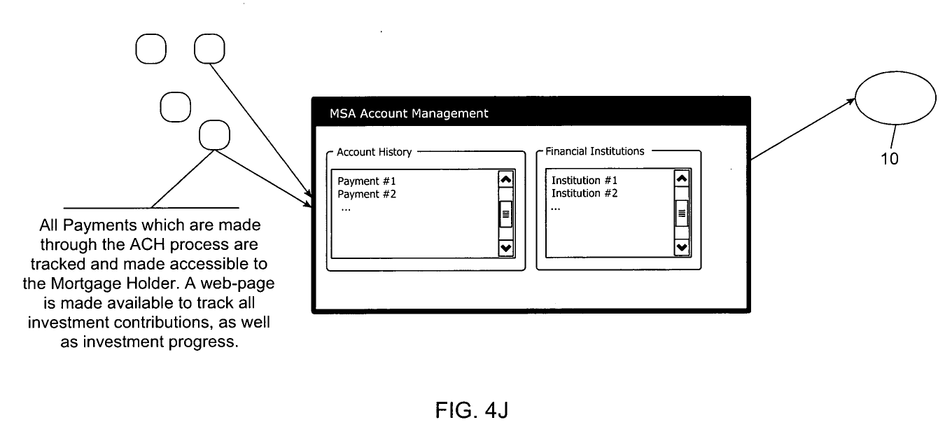

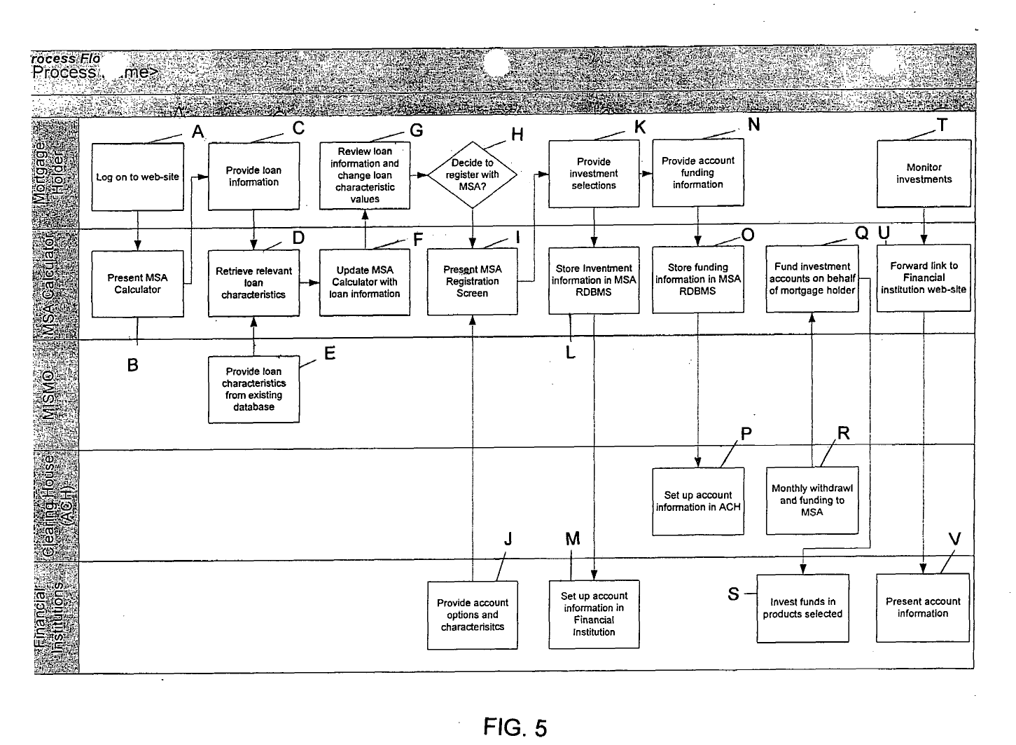

Having described the primary system architecture of the MSA Network of the present invention, as well as its basic components and service modules, it is appropriate at this juncture to now describe in greater detail, the interactive processes that are supported between a mortgage loan holder and the Web-based GUIs of the MSA Network, wherein reference should be made to the exemplary GUIs illustrated in FIGS. 4A through 4J, and the process flow diagram illustrated in FIG. 5.

After having been invited to the Web-site of network of the present invention, e.g. by way of a slip provided with ones monthly mortgage bill, an email inquiry received from the MSA Network administrator or marketing/sales department, or other method of notification, the first step of the interactive process shown in FIG. 4A involves the mortgage holder logging onto the Web-site of the MSA Network. After a quick registration (i.e. network user log-in) process, indicated at Block A in FIG. 5, the Mortgage Analysis and Savings Calculation Module provides the registered mortgage holder with a Web-based graphical user interface (GUI), as shown at Blocks B and C in FIG. 5 that allows him or her to enter all mortgage loan numbers and mortgage companies (holding the mortgage loans) into the RDBMS of the MSA Network. Such loan information can be obtained from monthly mortgage statements received by the mortgage holder.

As shown in FIG. 4B and at Blocks D of FIG. 5, the Mortgage Analysis and Savings Calculation Module uses these unique identifiers (i.e. loan number and mortgage company) as search keys to search for corresponding loan records in the MISMO database (i.e. the industry Loan Performance Database), and loads this information into the RDBMS of the MSA Network.

As shown in the GUI of FIG. 4C and Block E of FIG. 5, if the Mortgage Analysis and Savings Calculation Module identifies the loan in the MISMO database, then all characteristics of the loan are automatically returned from the MISMO to the Mortgage Analysis and Savings Calculation Module (i.e. storage in the RDBMS of the MSA Network); and if the Mortgage Analysis and Savings Calculation Module does not identified the loan in the MISMO database, then a null value is automatically returned to the Mortgage Analysis and Savings Calculation Module, indicating that the loan was not found in the MISMO database.

As shown in the GUI of FIG. 4D and Block F of FIG. 5, the Mortgage Analysis and Savings Calculation Module automatically updates the status field for each mortgage loan under analysis, indicating that the information has been received by the database server of the Internet-based MSA Network of the present invention.

As shown in the GUI of FIG. 4E, and Block G of FIG. 5, the user is provided with the opportunity to review the loan information, and change loan characteristic values, and upon pressing the OK (i.e. Savings Calculation) button, and the Mortgage Analysis and Savings Calculation Module automatically performs calculations on how much must be saved each month to make the total loan readjustment payment), and presents detailed screens indicating the same and related loan information, as shown in the GUI of FIG. 4E.

As shown in FIG. 4F, the Mortgage Analysis and Savings Calculation Module automatically uses detailed information retrieved from the MISMO database so as to populate the appropriate information fields in tabbed dialogue boxes labeled Loan Basics, Loan Resets, Floors, and Caps. At this stage, the user (i.e. mortgage loan holder) has the opportunity to modify any of the information provided in earlier steps (in accordance with What-If Analysis principles), and the Module automatically calculates the total amount to be saved per month. With each change to information provided to the Module, the Module automatically recalculates and presents a new total monthly amount to be saved by the mortgage holder.

As shown in the GUI of FIG. 4G at Block H in FIG. 5, the user decides to register (i.e. create) a MSA with the MSA Network, by pressing the OK button shown in FIG. 4E. As shown at Blocks I and J of FIG. 5, the MSA Network automatically advances control to the Mortgage MSA Registration and Set-Up Module, and the user is presented with a MSA Registration screen shown in FIG. 4G, displaying (i) various investment vehicles (“Options”) for implementing the MSA (and its calculated savings amounts) offered by various financial institutions registered on the Internet-based MSA Network of the present invention, as well as (ii) the Funding Source for funding the MSA, identified by its financial account number, ABA number, Routing Number, Data of Month to Withdraw, and Monthly Amount.

As shown in the GUI of FIG. 4H and at Block K of FIG. 5, the user is can select from the displayed MSA Registration screen, the investment vehicles (“Options”) for implementing the MSA (and its calculated savings amounts), and at show at Blocks L and M, upon making selections of investment products from this GUI screen, investment information is automatically stored in the RDBMS of the MSA Network, and a financial investment account is set up with the financial institution offering the investment product. These processes can involve the use of the MSA Networks communication, web, application and database servers.

As shown in the GUI of FIG. 4I and at Blocks N, O and P of FIG. 5, the user is asked to provide banking information in the Funding Source section of the GUI screen, instructing the MSA Network to automatically withdraw funds in accordance with the information provided and required to implement the MSA. As indicated at Block P in FIG. 5, the account information associated with the registered MSA is then used to set up account information in the ACH processing center associated with the MSA Network of the present invention, while the Mortgage Analysis and Savings Calculation Module automatically verifies the validity of the information entered using this GUI screen.

As indicated at Blocks Q in FIG. 5, the MSA Registration and Set-Up Module oversees that the investment accounts (selected by the mortgage holder to implement the MSA) are funded using the financial sources selected when using the GUI screen of FIG. 4H. As indicated at Block R, this module ensures that monthly funds from identified funding sources are withdrawn automatically on a monthly basis, via the ACH processing system, and as indicated at Block S, are automatically deposited into the financial products/vehicles which have been selected by the mortgage holder to implement the MSA on the MSA Network of the present invention.

As shown in the GUI of FIG. 4J and at Blocks T, IU and V of FIG. 5, the mortgage holder who has set up a MSA on the MSA Network of the present invention may, at any time, display MSA Account Management GUI screen shown in FIG. 4J, and review (i) the history of payments made into any particular MSA set up on the MSA Network of the present invention, as well as (ii) the status of those investments. Using this GUI screen, the mortgage holder may also select the financial institution implementing the MSA, and take the mortgage (and MSA) holder directly to the WWW site of the financial institution for tracking funds deposited with and managed by this financial institution (i.e. vendor).

Having described the illustrative embodiments of the present invention, a number of modifications and variations readily come to mind.

While the illustrative embodiment of the present invention describes mortgage loan service providers as ones who lead the risk mitigation process conducted over the MSA Network of the present invention, it is understood that in other illustrative embodiments, the mortgage loan holder and/or the financial institutions can lead the process. Also, instead of the MISMO database providing loan specifics into the RDBMS of the MSA Network, the mortgage loan holder may enter loan specifics into the Network.

While various illustrative embodiments of the present invention have been disclosed in great detail herein above, is understood that the Internet-based MSA Network of the present invention of the illustrative embodiments may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

What is claimed is:

1. An Internet-based method for helping holders of an adjustable rate mortgage (ARM) or interest only (IO) loan to mitigate the risks associated with mortgage rate changes and readjustment payment vulnerability, said Internet-based method comprising the steps of:
(a) delivering ARM or IO loan holders with invitations to use and subscribe to services offered on an Internet-based mortgage analysis and savings registration, set-up and management network (MSA network);
(b) allowing ARM or IO loan holders to register with said MSA Network, and calculate a monthly savings amount that would be required to cover the loan readjustment in the event of an interest rate change on said mortgage loan;
(c) selecting investment vehicles and funding sources with which to fund a mortgage savings account (MSA) registered, implemented and managed using said MSA network;
(d) on periodic basis, using an automated clearing house system (ACH) for automatically withdrawing funds from said selected financial sources and depositing withdrawn funds, into said selected financial investment vehicles so as to implement said MSA; and
(e) monitoring the performance of the implemented MSA, including monthly deposits and balances made in connection therewith.

2. The Internet-based method of claim 1, wherein step (a) comprises contacting holders of ARM or IO loans through a method selected from the group consisting of: email transmission, and transmission of slips/notices placed within an envelope accompanying monthly bills for said ARM loan issued from a mortgage loan service provider registered with said MSA Network.

3. The Internet-based method of claim 1, wherein step (b) comprises enabling the ARM or IO loan holder to perform what-if analysis with respect to said ARM or IO loan.

4. The Internet-based method of claim 1, which further comprises step (f) allowing financial institutions to register with said MSA Network as a financial institution (i.e. financial product vendor) that offers and support financial products which qualify as financial vehicles for implementing MSAs on said MSA Network, for eligible ARM or IO loan holders.

5. The Internet-based method of claim 5, which further comprises step (g) allowing the ARM or IO loan service providers to register with said MSA Network.

6. The Internet-based method of claim 1, which further comprises step (h) allowing the ARM loan holder to register with said MSA Network.

7. The Internet-based method of claim 1, wherein step (i) comprises allowing the ARM or IO loan holder to set-up and implement the MSA with a selected registered financial institution on said MSA Network.

8. The Internet-based method of claim 1, wherein step (c) comprises allowing the ARM or IO loan holder, to register the MSA with said MSA Network, and set-up and implement said MSA with a selected registered financial institution on said MSA Network.

9. The Internet-based method of claim 1, which further comprises automatically collect MSA-related information from registered financial institutions offering and supporting implemented MSAs on said MSA Network, and presenting an eighth Web-based GUI to the ARM or IO loan holder for allowing the MSA holder to monitor the MSA and financial institutions to monitor information regarding MSA funding, and aggregate reports produced on MSAs.

10. The Internet-based method of claim 1, wherein step (b) comprises allowing the ARM or IO loan holder to supply ARM loan data, to the MSA network, including information items selected from the group consisting of (i) the size of the loan, (iii) the term of loan and periodicity, (iii) reset dates, and (iv) periodic and lifetime caps and floors on interest rates.

11. The Internet-based method of claim 1, wherein step (b) comprises using simplifying default assumptions so that the ARM or IO loan holder does not need to become initially bewildered by all the factors that can apply in ARM loan scenarios.

12. The Internet-based method of claim 11, wherein said simplifying assumptions include the projecting of: (1) the amount that needs to be saved will be the sum of the new payments over the length of the new adjustment period minus the sum of existing payments over that period; and (2) the amount to be saved is a gross amount with no interest accruing during the re-set period and, a fortiori, with no compounding of interest.

13. The Internet-based method of claim 12, wherein step (b) comprises using said simplifying assumptions, and then automatically calculating the monthly savings amount that the ARM or IO loan holder needs to pay into said MSA, by dividing the total amount computed using said simplifying assumption above, by the number of months left until interest rate re-adjustment occurs.

14. The Internet-based method of claim 1, wherein step (b) comprises allowing the ARM or IO loan holder to enter relevant loan characteristics into a database associated with said MSA Network, or import such loan information from a database server maintained by the ARM loan service provider, or other appropriate database.

15. The Internet-based method of claim 1, wherein the implemented MSA serves as a buffer to mitigate negative events associated with interest rate increases on the ARM or IO loan, so that the ARM or IO mortgage holder will be less likely to have its mortgage loan fall into delinquency or default, and face the possibility of losing their home.

16. The Internet-based method of claim 1, wherein said MSA Network comprises a network of proxy servers, management servers, web (http) servers, application servers and database servers operably connected to the infrastructure of the Internet, for implementing the presentation, control and data entity layers of said MSA Network.

17. An Internet-based system for helping holders of adjustable rate mortgage (ARM) or Interest only (IO) loans to mitigate the risks associated with mortgage rate changes and readjustment payment vulnerability, said Internet-based system comprising:
a subsystem for delivering ARM or IO loan holders with invitations to use and subscribe to services offered on said Internet-based system, and
an information server supporting first, second, third and fourth service modules for providing said services to the ARM or IO loan holder,
wherein said first service module allows the ARM or IO loan holder to register with said MSA Network, perform what-if analysis with respect to its ARM or IO loan, and calculate a monthly savings amount that would be required to cover the loan readjustment in the event of an interest rate change on said ARM or IO loan;
wherein said second service module allows the ARM or IO loan holder to select investment vehicles and funding sources with which to fund a mortgage savings account (MSA) registered, implemented and managed using said MSA system;
wherein said third service module, employs an automated clearing house (ACH) system, for automatically withdrawing funds from said selected financial sources and depositing withdrawn funds, into said selected financial investment vehicles so as to implement said MSA; and
wherein said fourth service module allows the ARM or IO loan holder to monitor the performance of the implemented MSA, including monthly deposits and balances made in connection therewith.

18. The Internet-based system of claim 17, wherein said subsystem comprises means for contacting holders of ARM or IO loans through a method selected from the group consisting of: email transmission, and transmission of slips/notices placed within an envelope accompanying monthly bills for said ARM or IO loan issued from a mortgage loan service provider registered with said MSA system.

19. The Internet-based system of claim 17, wherein said first service module further comprises a Web server for presenting a first Web-based graphical user interface (GUI) to the ARM or IO loan holder, for enabling the mortgage holder to calculate how much money will need to be saved in said MSA each month in order to make the re-adjustment payment required on said ARM loan.

20. The Internet-based system of claim 17, which further comprises a fifth service module for presenting a second Web-based GUI to financial institutions, for allowing the financial institutions to register with said MSA system as a financial institution (i.e. financial product vendor) that offers and support financial products which qualify as financial vehicles for implementing MSAs on said MSA system, for eligible ARM or IO loan holders.

21. The Internet-based system of claim 17, which further comprises a sixth service module for presenting a third Web-based GUI to the ARM or IO loan service providers, for allowing the ARM or IO loan service providers to register with said MSA system.

22. The Internet-based system of claim 17, which further comprises a seventh service module for presenting a fourth Web-based GUI to the ARM or IO loan holder, for allowing the ARM or IO loan holder to register with said MSA Network and to set-up and implement the MSA with a selected registered financial institution on said MSA system.

23. The Internet-based system of claim 17, which further comprises a fifth service module for automatically collecting MSA-related information from registered financial institutions offering and supporting implemented the MSA on said MSA system, and providing a Web-based GUI for allowing the MSA holder to monitor the MSA and financial institutions to monitor information regarding MSA funding, and aggregate reports produced on MSAs.

24. The Internet-based system of claim 17, wherein said first service module comprises presenting a Web-based GUI to the ARM or IO loan holder for supplying ARM or IO loan data, to the MSA system, including information items such as (i) the size of the loan, (iii) the term of loan and periodicity, (iii) reset dates, and (iv) periodic and lifetime caps and floors on interest rates.

25. The Internet-based system of claim 17, wherein said second service module comprises using simplifying default assumptions so that the ARM or IO loan holder does not need to become initially bewildered by all the factors that can apply in ARM or IO loan scenarios.

26. The Internet-based system of claim 25, wherein said simplifying assumptions include the projecting of: (1) the amount that needs to be saved will be the sum of the new payments over the length of the new adjustment period minus the sum of existing payments over that period; and (2) the amount to be saved is a gross amount with no interest accruing during the re-set period and, a fortiori, with no compounding of interest.

27. The Internet-based system of claim 26, wherein said second service module comprises uses said simplifying assumptions, and then automatically calculates the monthly savings amount that the ARM or IO loan holder needs to pay into said MSA, by dividing the total amount computed using said simplifying assumption above, by the number of months left until interest rate re-adjustment occurs.

28. The Internet-based system of claim 17, wherein said first service module comprises presenting a Web-based GUI to the ARM or IO loan holder, for allowing the ARM or IO loan holder to enter relevant loan characteristics into a database associated with said MSA system, or import such loan information from a database server maintained by the ARM or IO loan service provider, or other appropriate database.

29. The Internet-based system of claim 17, wherein the implemented MSA serves as a buffer to mitigate negative events associated with interest rate increases on the ARM or IO loan, so that the ARM or IO mortgage holder will be less likely to have its mortgage loan fall into delinquency or default, and face the possibility of losing their home.

30. The Internet-based system of claim 17, which further comprises a network of proxy servers, management servers, web (http) servers, application servers and database servers operably connected to the infrastructure of the Internet, for implementing presentation, control and data entity layers of said MSA system.
